(19) United States
(12) Patent Application Publication
(10) Pub. No.: US 2022/0217545 A1
(43) Pub. Date: Jul. 7, 2022

(54) STATION SETTING SUPPORT METHOD AND STATION SETTING SUPPORT SYSTEM

(71) Applicant: NIPPON TELEGRAPH AND TELEPHONE CORPORATION, Tokyo (JP)

(72) Inventors: Toshiro NAKAHIRA, Musashino-shi, Tokyo (JP); Hirantha ABEYSEKERA, Musashino-shi, Tokyo (JP); Shoko SHINOHARA, Musashino-shi, Tokyo (JP); Koichi ISHIHARA, Musashino-shi, Tokyo (JP); Yasuhiko INOUE, Musashino-shi, Tokyo (JP); Takafumi HAYASHI, Musashino-shi, Tokyo (JP); Yasushi TAKATORI, Musashino-shi, Tokyo (JP)

(73) Assignee: NIPPON TELEGRAPH AND TELEPHONE CORPORATION, Tokyo (JP)

(21) Appl. No.: 17/600,574

(22) PCT Filed: Mar. 24, 2020
(86) PCT No.: PCT/JP2020/013134

§ 371 Date: Sep. 30, 2021

(30) Foreign Application Priority Data
Apr. 2, 2019 (JP) 2019-070924

(51) Int. Cl. H04W 16/22; H04B 17/373; H04B 17/391; H04B 17/309

(52) U.S. Cl. CPC H04W 16/22; H04B 17/309; H04B 17/391; H04B 17/373

(57) ABSTRACT

A station installation support system for performing a station installation design of a wireless base station satisfying a required performance and a parameter design includes a station installation support device that acquires a station installation calculation condition required to calculate a station installation of the wireless base station, a parameter calculation condition required to calculate a parameter of the wireless base station, a wireless performance evaluation condition required to evaluate a wireless performance, and a station installation evaluation condition required to evaluate the station installation and performs the station installation design and the parameter design, a wireless signal evaluation unit that outputs a wireless signal evaluation result corresponding to wireless signal evaluation information, a station installation calculation unit that outputs a station installation calculation result corresponding to station installation calculation information, a parameter calculation unit that outputs a parameter calculation result corresponding to parameter calculation information, and a wireless performance evaluation unit that outputs a wireless performance evaluation result corresponding to wireless performance evaluation information.

### TECHNICAL FIELD

The present invention relates to a station installation support method and a station installation support system for performing a station installation design of a wireless base station based on a required performance and a wireless parameter design.

### BACKGROUND ART

In recent years, as wireless terminals such as smartphones and tablets have rapidly spread, the number of users of large-capacity content by wireless terminals has been increasing, and a traffic amount on a wireless network has been rapidly increasing. To accommodate wireless traffic at low cost and readily, the IEEE802.11 wireless LAN standard described in Non Patent Literature 1 that has been widespread as a high-speed wireless access system using a radio wave in an unlicensed wireless system band has been frequently used. Wireless LAN networks have been provided in various areas such as private areas including homes and offices and public areas including shops, train stations, and airports.

In constructing the wireless LAN network, the wireless LAN network needs to be constructed in consideration of various elements such as an operation of a wireless base station, a wireless LAN communication portion such as a parameter setting, a network portion between a wireless base station and a switch or between a switch and a backhaul line, for example, and an upper service portion such as a user authentication or a portal screen. Among them, a station installation of a wireless base station and a setting of a wireless parameter are paid attention to in the present invention.

Generally, when a wireless signal is attenuated by a propagation distance or a shield in wireless communication, a quality and a capacity of wireless communication decrease. Accordingly, a state where a distance between a wireless base station and a wireless terminal station is short and a prospect of a propagation path can be ensured is desirable. On the other hand, the number of installations of the wireless base station is restricted by costs required for an equipment device, an installation, and an operation, further a wireless radio wave interference, and the like. Accordingly, it is important to install a required number of wireless base stations at an appropriate location for an area covered by a wireless LAN. The respective numbers of traffics and users that can be accommodated in one wireless base station are limited. Therefore, a wireless base station may be additionally provided as the number of wireless LAN users increases. In this case, it is also important to perform a station installation design of the wireless base station to be additionally provided and a wireless parameter design.

If an attempt to simultaneously perform different communications on the same frequency channel is made in wireless communication, it is known that the communications cannot be normally performed due to reasons that wireless signals interfere with each other so that a signal cannot be successfully detected and a communication error occurs, for example. Accordingly, it is important to perform a station installation design of a wireless base station and a wireless parameter design.

Further, to grasp to what degree a wireless communication performance is actually obtained after the station installation design of the wireless base station and the wireless parameter design are performed, it is also important to perform a wireless performance evaluation and confirm whether or not an assumed wireless performance is obtained.

### CITATION LIST

### Non-Patent Literature

Non-Patent Literature 1: IEEE Std 802.11-2016, Dec. 2016.

### SUMMARY OF THE INVENTION

### Technical Problem

There exist pieces of software that respectively perform a station installation design of a wireless base station, a wireless parameter optimization, and a wireless performance evaluation. However, the pieces of software cannot be integrally used. For example, a plurality of station installation patterns are prepared, and a wireless parameter optimization is performed for each of the station installation patterns. To perform a wireless performance evaluation, a user needs to manually generate a plurality of patterns using each of the pieces of software and perform a wireless performance evaluation by applying the wireless parameter optimization so that much time and effort and a large operation amount are required.

The present invention is directed to providing a station installation support method and a station installation support system in which a station installation design of a wireless base station based on a required performance and a wireless parameter design can be performed in a small operation amount.

### Means for Solving the Problem

A first aspect of the invention provides a station installation support method for performing a station installation design of a wireless base station satisfying a required performance and a parameter design, the station installation support method including a step 1 of acquiring a station installation calculation condition required to calculate a station installation of the wireless base station, a parameter calculation condition required to calculate a parameter of the wireless base station, a wireless performance evaluation condition required to evaluate a wireless performance, and a station installation evaluation condition required to evaluate the station installation, a step 2 of outputting wireless signal evaluation information required to measure a wireless environment to a wireless signal evaluation unit to acquire a wireless signal evaluation result, a step 3 of outputting station installation calculation information generated based on the station installation calculation condition and the wireless signal evaluation result to a station installation calculation unit to acquire a station installation calculation result, compiling a station installation calculation result that matches the station installation evaluation condition to generate a station installation pattern, and correcting station installation calculation information when a station installation calculation result that matches the station installation evaluation condition is not obtained and repeating acquisition of a station installation calculation result, a step 4 of outputting parameter calculation information generated based on the station installation pattern, the parameter calculation condition, and the wireless signal evaluation result to a parameter calculation unit to acquire a parameter calculation result, compiling a parameter calculation result that matches the parameter calculation condition to generate a parameter pattern, and correcting the parameter calculation information when a parameter calculation result that matches the parameter calculation condition is not obtained and repeating acquisition of a parameter calculation result, a step 5 of outputting wireless performance evaluation information generated based on the parameter pattern, the wireless performance evaluation condition, and the wireless signal evaluation result to a wireless performance evaluation unit to acquire a wireless performance evaluation result, compiling a wireless performance evaluation result that matches the wireless performance evaluation condition to generate a wireless performance evaluation pattern, correcting the station installation calculation information and the parameter calculation information when a wireless performance evaluation result that matches the wireless performance evaluation condition is not obtained and returning to the step 3, and a step 6 of generating a station installation evaluation result to be provided for a station installation design of the wireless base station and a parameter design based on the wireless performance evaluation pattern, the station installation evaluation condition, the wireless signal evaluation result, and the station installation pattern.

In the station installation support method according to the first aspect of the invention, in the step 4 and the step 5, the order of performing a parameter calculation and a wireless performance evaluation is determined based on an evaluation performance priority in the station installation pattern generated in the step 3, the acquired wireless performance evaluation result is determined, and subsequent performance of the parameter calculation and the wireless performance evaluation for the station installation pattern is terminated when a required condition is satisfied.

A second aspect of the invention is a station installation support system for performing a station installation design of a wireless base station satisfying a required performance and a parameter design, the station installation support system including a station installation support device that acquires a station installation calculation condition required to calculate a station installation of the wireless base station, a parameter calculation condition required to calculate a parameter of the wireless base station, a wireless performance evaluation condition required to evaluate a wireless performance, and a station installation evaluation condition required to evaluate the station installation and performs the station installation design and the parameter design, a wireless signal evaluation unit that outputs a wireless signal evaluation result corresponding to wireless signal evaluation information, a station installation calculation unit that outputs a station installation calculation result corresponding to station installation calculation information, a parameter calculation unit that outputs a parameter calculation result corresponding to parameter calculation information, and a wireless performance evaluation unit that outputs a wireless performance evaluation result corresponding to wireless performance evaluation information, in which the station installation support device generates wireless signal evaluation information and outputs the wireless signal evaluation information to the wireless signal evaluation unit, generates the station installation calculation information based on the station installation calculation condition and the wireless signal evaluation result, generates a station installation pattern based on the station installation calculation result outputted by the station installation calculation unit, which matches the station installation evaluation condition, generates the parameter calculation information based on the station installation pattern, the parameter calculation condition, and the wireless signal evaluation result, generates a parameter pattern based on the parameter calculation result outputted by the parameter calculation unit, which matches the parameter calculation condition, generates the wireless performance evaluation information based on the parameter pattern, the wireless performance evaluation condition, and the wireless signal evaluation result, generates a wireless performance evaluation pattern based on the wireless performance evaluation result outputted by the wireless performance evaluation unit, which matches the wireless performance evaluation condition, and generates a station installation evaluation result of the wireless based station based on the wireless performance evaluation pattern, the station installation evaluation condition, the wireless signal evaluation result, and the station installation pattern.

In the station installation support system according to the second aspect of the invention, the station installation support device is configured to determine the order of performing a parameter calculation and a wireless performance evaluation based on an evaluation performance priority in the station installation pattern, determines the acquired wireless performance evaluation result, and terminates subsequent performance of the parameter calculation and the wireless performance evaluation for the station installation pattern when a required condition is satisfied.

### Effects of the Invention

According to the present invention, when the station installation support device includes a common interface that communicates with a user, a wireless signal evaluation unit, a station installation calculation unit, a parameter calculation unit, and a wireless performance evaluation unit, and exchanges information with the units, the user can integrally use the units. After a plurality of station installation patterns of a wireless base station are generated, and respective priorities of the station installation patterns are evaluated, a parameter calculation and a wireless performance evaluation are performed, thereby enabling the station installation pattern satisfying a required performance to be derived in a small operation amount.

### BRIEF DESCRIPTION OF DRAWINGS

FIG. 1 is a diagram illustrating a configuration example of a station installation support system in the present invention.

FIG. 2 is a diagram illustrating a processing sequence of a station installation support device 10.

FIG. 3 is a diagram illustrating an example of a station installation calculation condition.

FIG. 4 is a diagram illustrating an example of a parameter calculation condition.

FIG. 5 is a diagram illustrating an example of a wireless performance evaluation condition.

FIG. 6 is a diagram illustrating an example of a station installation evaluation condition.

FIG. 7 is a diagram illustrating an example of a wireless signal evaluation result.

FIG. 8 is a diagram illustrating an example of a station installation pattern.

FIG. 9 is a diagram illustrating an example of a parameter pattern.

FIG. 10 is a diagram illustrating an example of a wireless performance evaluation pattern.

FIG. 11 is a diagram illustrating an example of a station installation evaluation result.

FIG. 12 is a flowchart illustrating an example of a processing procedure of a station installation support device 10.

FIG. 13 is a flowchart illustrating an example of a setting processing procedure of respective evaluation performance priorities for station installation patterns.

### DESCRIPTION OF EMBODIMENTS

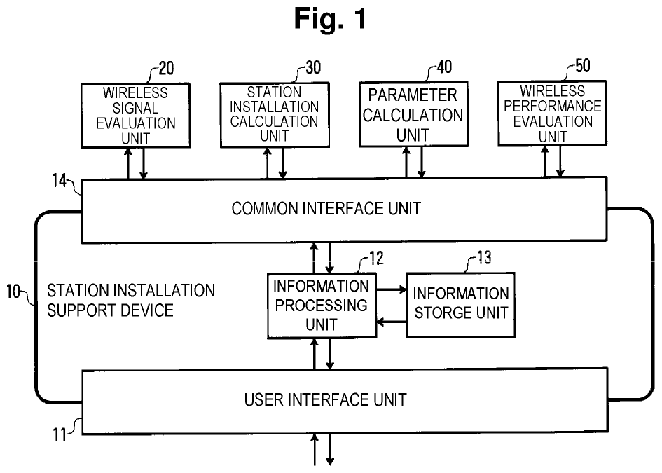

FIG. 1 illustrates a configuration example of a station installation support system in the present invention.

In FIG. 1, the station installation support system includes a station installation support device 10, a wireless signal evaluation unit 20, a station installation calculation unit 30, a parameter calculation unit 40, and a wireless performance evaluation unit 50. The units may be respectively configured by pieces of software. The station installation support device 10 includes a user interface unit 11, an information processing unit 12, an information storage unit 13, and a common interface unit 14.

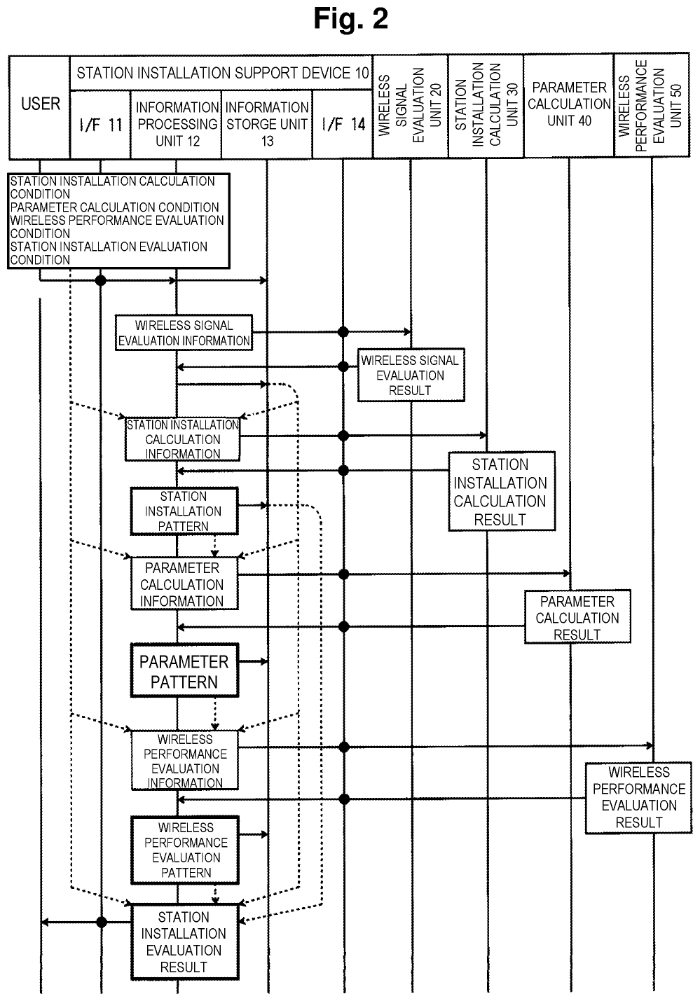

Here, description is made with reference to FIG. 2 illustrating a processing sequence of the station installation support device 10.

The user interface unit 11 inputs a station installation calculation condition, a parameter calculation condition, a wireless performance evaluation condition, and a station installation evaluation condition that are set by a user and outputs the conditions to the information processing unit 12, and outputs a station installation evaluation result processed by the information processing unit 12 to the user.

The information processing unit 12 has three functions, i.e., an information generation function, an information input-output function, and an information recording-reading function. The information generation function is for generating wireless signal evaluation information to be outputted to the wireless signal evaluation unit 20, and generating station installation calculation information based on the station installation calculation condition set by the user and a wireless signal evaluation result acquired from the wireless signal evaluation unit 20. The information generation function is for generating a station installation pattern based on the station installation calculation result acquired from the station installation calculation unit 30. The information generation function is for generating parameter calculation information to be outputted to the parameter calculation unit 40 based on the station installation pattern and the parameter calculation condition set by the user. The information generation function is for generating a parameter pattern based on a parameter calculation result acquired from the parameter calculation unit 40. The information generation function is for generating wireless performance evaluation information to be outputted to the wireless performance evaluation unit 50 based on the parameter pattern and the wireless performance evaluation condition set by the user. The information generation function is for generating a station installation evaluation result based on the wireless performance evaluation result acquired from the wireless performance evaluation unit 50, the station installation evaluation condition set by the user, and the station installation pattern.

In the information input-output function, the station installation calculation condition and the station installation evaluation function to be set by the user via the user interface unit 11 are acquired. In the information input-output function, the wireless signal evaluation information is outputted to the wireless signal evaluation unit 20 via the common interface unit 14 to acquire a wireless signal evaluation result, the station installation calculation information is outputted to the station installation calculation unit 30 to acquire the station installation calculation result, the parameter calculation information is outputted to the parameter calculation unit 40 to acquire the parameter calculation result, and the wireless performance evaluation information is outputted to the wireless performance evaluation unit 50 to acquire the wireless performance evaluation result. In the information input-output function, the station installation calculation result and the station installation evaluation result are outputted to the user via the user interface unit 11.

In the information recording-reading function, information is recorded on the information storage unit 13, and is read out of the information storage unit 13.

The information storage unit 13 records information to be inputted from the information processing unit 12, and outputs information recorded based on an instruction from the information processing unit 12.

The common interface unit 14 interconverts information formats, and the like to exchange information between the information processing unit 12 and the wireless signal evaluation unit 20 to the wireless performance evaluation unit 50.

The wireless signal evaluation unit 20 outputs the wireless signal evaluation result corresponding to wireless signal evaluation information to the information processing unit 12 via the common interface unit 14. In the wireless signal evaluation unit 20, the wireless signal evaluation result may be acquired by measuring a wireless signal, or may be acquired based on a propagation simulation or the like. The station installation calculation unit 30 outputs a station installation calculation result corresponding to the station installation calculation information to the information processing unit 12 via the common interface unit 14. The parameter calculation unit 40 outputs the parameter calculation result corresponding to the parameter calculation information to the information processing unit 12 via the common interface unit 14. The wireless performance evaluation unit 50 outputs the wireless performance evaluation result corresponding to the wireless performance evaluation information to the information processing unit 12 via the common interface unit 14.

Here, each of terms will be described.

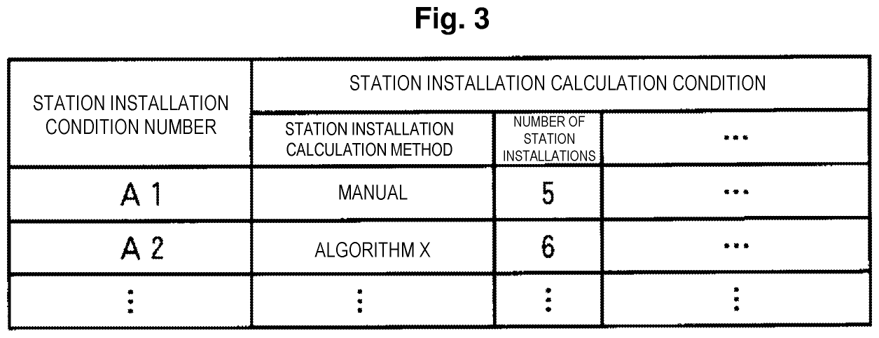

An example of the station installation calculation condition is illustrated in FIG. 3. As illustrated in FIG. 3, the station installation calculation condition includes information as a condition in calculating a station installation, and includes a station installation condition number, and a station installation calculation method (an algorithm for calculating a station installation, etc.), the number of station installations, and the like as a station installation calculation condition. As illustrated in FIG. 3, when a plurality of station installation calculation conditions are set by the user, a calculation of a plurality of station installations and a station installation evaluation can be performed.

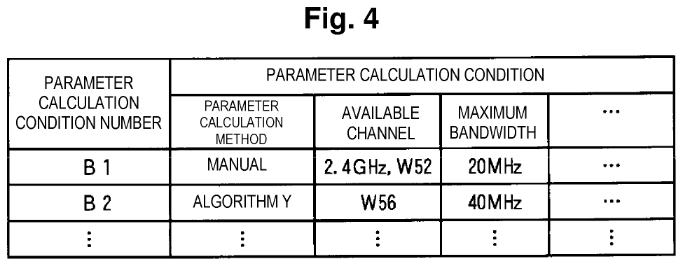

An example of the parameter calculation condition is illustrated in FIG. 4. As illustrated in FIG. 4, the parameter calculation condition includes information as a condition in calculating a parameter, and includes a parameter calculation condition number, and a parameter calculation method, an available channel, a maximum bandwidth, and the like as a parameter calculation condition. As illustrated in FIG. 4, when a plurality of parameter calculation conditions are set by the user, a station installation evaluation can be performed using the plurality of parameter calculation conditions.

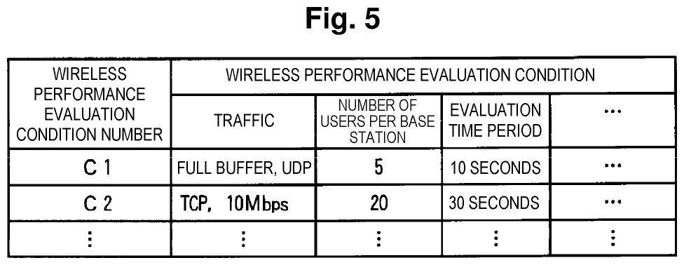

An example of the wireless performance evaluation condition is illustrated in FIG. 5. As illustrated in FIG. 5, the wireless performance evaluation condition includes information as a condition in evaluating a wireless performance, and includes a wireless performance evaluation condition number, and a traffic, the number of users per base station, an evaluation time period, and the like as a wireless performance evaluation condition. As illustrated in FIG. 5, when a plurality of wireless performance evaluation conditions are set by the user, a station installation evaluation can be performed using the plurality of wireless performance evaluation conditions.

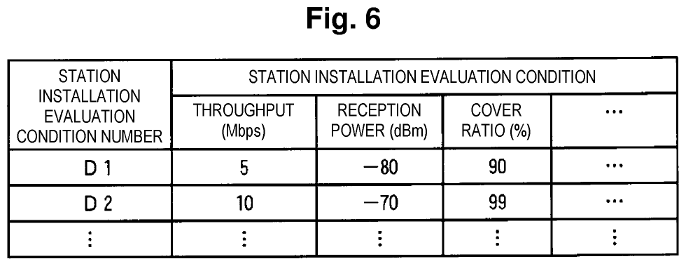

An example of the station installation evaluation condition is illustrated in FIG. 6. As illustrated in FIG. 6, the station installation evaluation condition includes information about an evaluation condition for a station installation calculation result, and includes a station installation evaluation condition number, and a throughput, a reception power, a cover ratio, and the like as a station installation evaluation condition. As illustrated in FIG. 6, when a plurality station installation evaluation conditions are set by the user, a station installation evaluation using the plurality of evaluation conditions can be performed.

The wireless signal evaluation information includes information as a wireless signal evaluation condition, and is a signal for instructing the wireless signal evaluation unit 20 to output a wireless signal evaluation result.

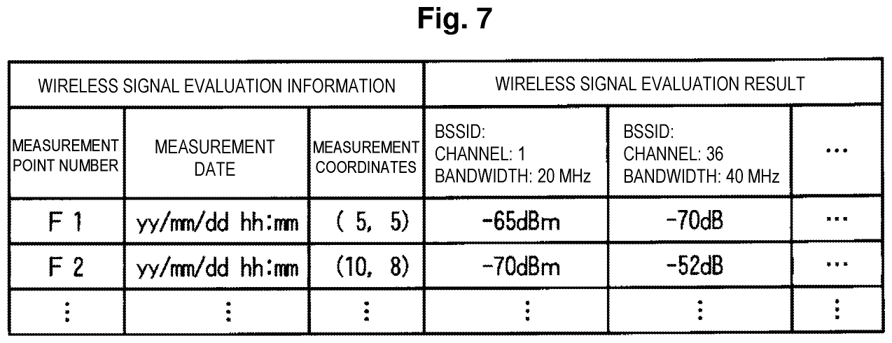

An example of the wireless signal evaluation result is illustrated in FIG. 7. As illustrated in FIG. 7, there is a wireless signal evaluation result (a BSSID, a channel, a bandwidth, a reception power value, and the like) for a measurement point number, a measurement date, and measurement coordinates as wireless signal evaluation information.

The station installation calculation information is generated as input information for combining the wireless signal evaluation result acquired from the wireless signal evaluation unit 20 and the station installation calculation condition set by the user and causing the station installation calculation unit 30 to perform a station installation calculation.

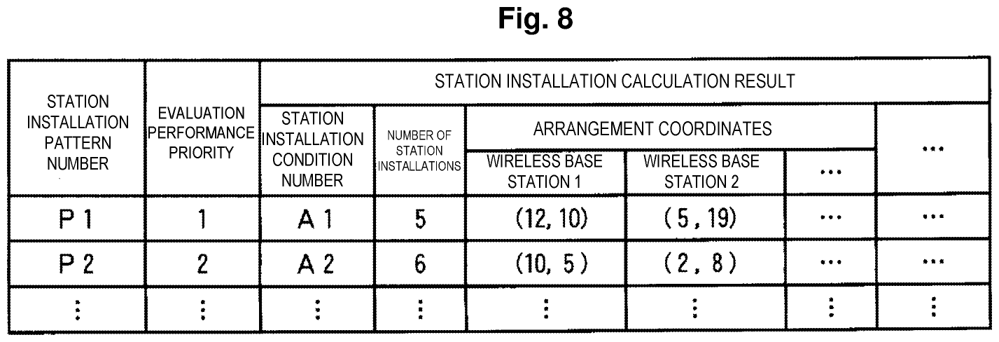

An example of the station installation pattern is illustrated in FIG. 8. As illustrated in FIG. 8, the station installation pattern is obtained by respectively acquiring station installation calculation results for station installation pattern numbers from the station installation calculation unit 30, compiling the station installation calculation results by the information processing unit 12, and adding evaluation performance priority information to the station installation calculation results. The station installation pattern includes a station installation pattern number, an evaluation performance priority, and a station installation condition number, the number of station installations, station installation coordinates, and the like as a station installation calculation result.

The parameter calculation information is generated as input information for combining the parameter calculation condition set by the user, the station installation pattern, and the wireless signal evaluation result acquired from the wireless signal evaluation unit 20 and calculating a parameter for the parameter calculation unit 40.

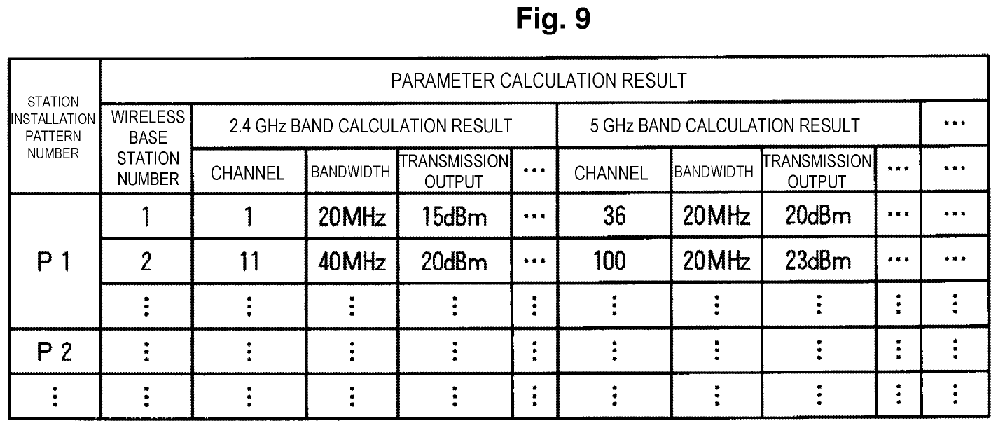

An example of the parameter pattern is illustrated in FIG. 9. As illustrated in FIG. 9, the parameter pattern is obtained by respectively acquiring parameter calculation results from the parameter calculation unit 40 for station installation pattern numbers and compiling the parameter calculation results by the information processing unit 12. The parameter pattern includes a station installation pattern number, and a wireless base station number, a 2.4 GHz band calculation result (a channel, a bandwidth, a transmission output, etc.), a 5 GHz band calculation result (a channel, a bandwidth, a transmission output, etc.), and the like as the parameter calculation result.

The wireless performance evaluation information is generated as input information for combining the wireless performance evaluation condition set by the user, the parameter pattern, and the wireless signal evaluation result acquired by the wireless signal evaluation unit 20 and causing the wireless performance evaluation unit 50 to evaluate a wireless performance.

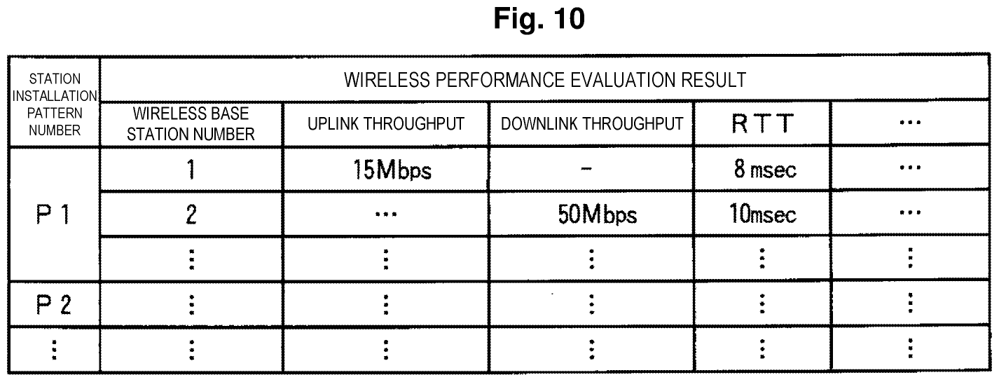

An example of the wireless performance evaluation pattern is illustrated in FIG. 10. As illustrated in FIG. 10, the wireless performance evaluation pattern is obtained by respectively acquiring wireless performance evaluation results from the wireless performance evaluation unit 50 for station installation pattern numbers and compiling the wireless performance evaluation results by the information processing unit 12. The wireless performance evaluation pattern includes a station installation pattern number, and a wireless base station number, an uplink throughput, a downlink throughput, an RTT (round trip time), and the like as a wireless performance evaluation result.

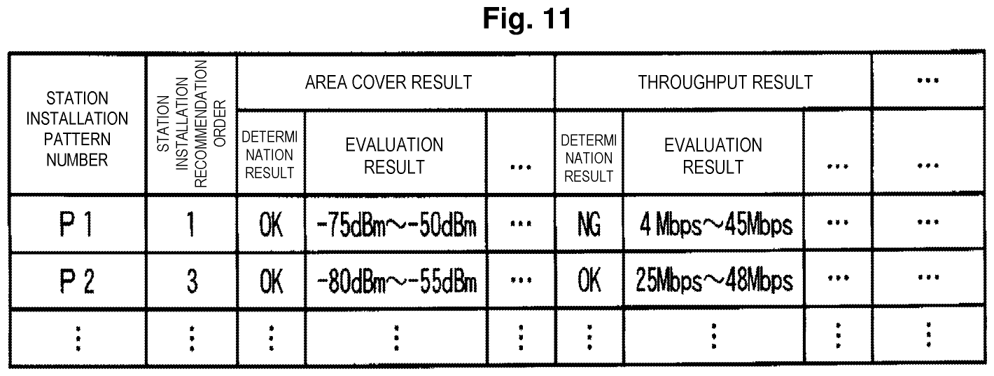

An example of the station installation evaluation result is illustrated in FIG. 11. As illustrated in FIG. 11, the station installation evaluation result is obtained by compiling respective evaluation results for the station installation pattern, the wireless signal evaluation result, and the wireless performance evaluation pattern by the information processing unit 12 based on the station installation evaluation condition set by the user. The station installation evaluation result includes a station installation pattern number, a station installation recommendation order, an area cover result (a determination result, an evaluation result, etc.), a throughput result (a determination result, an evaluation result, etc.), and the like.

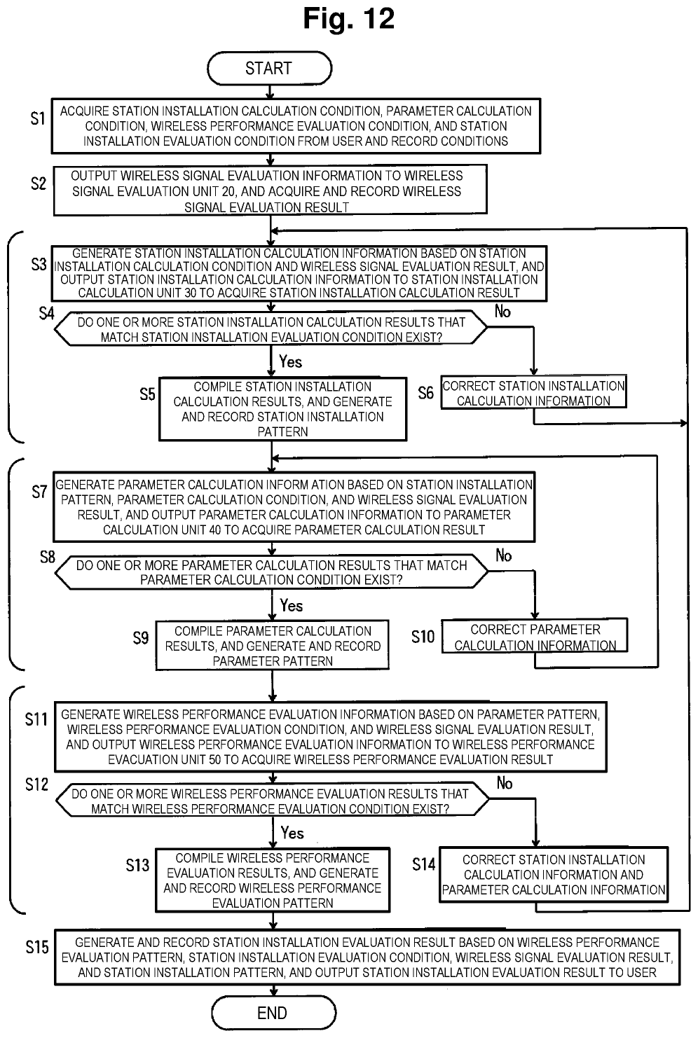

FIG. 12 illustrates an example of a processing procedure of the station installation support device 10.

In FIG. 12, the station installation support device 10 first acquires and records a station installation calculation condition, a parameter calculation condition, a wireless performance evaluation condition, and a station installation evaluation condition by the user (step S1).

Then, the station installation support device 10 outputs wireless signal evaluation information to the wireless signal evaluation unit 20, and acquires and records a wireless signal evaluation result (step S2).

Then, the station installation support device 10 generates station installation calculation information based on the station installation calculation condition and the wireless signal evaluation result, and outputs the generated station installation calculation information to the station installation calculation unit 30 to acquire a station installation calculation result (step S3).

Then, the station installation support device 10 determines whether or not one or more station installation calculation results that match the station installation evaluation condition exist (step S4). If the one or more station installation calculation results that match the station installation evaluation condition exist (Yes in step S4), the station installation support device 10 compiles the station installation calculation results that match the station installation evaluation condition, and generates and records a station installation pattern (step S5). In step S5, an evaluation performance priority in the station installation pattern can be set (details thereof is described below). If the station installation calculation results that match the station installation evaluation condition do not exist in the determination in step S4 (No in step S4), the station installation support device 10 corrects the station installation calculation information (step S6), and the processing returns to step S3.

The station installation evaluation condition includes information as an evaluation condition for the station installation calculation result. Examples of the station installation evaluation condition include a distance between wireless base stations, a size of a cover area of each of the wireless base stations, and an assumed reception power in the area.

Examples of correction of the station installation calculation information include a change in the station installation calculation method and an increase in the number of station installations. If the station installation calculation result does not match the station installation evaluation condition because the number of station installations is small, for example, the cover area is widened by increasing the number of station installations so that a station installation calculation result that matches the station installation evaluation condition is easily obtained.

Then, the station installation support device 10 generates parameter calculation information based on the station installation pattern, the parameter calculation condition, and the wireless signal evaluation result, and outputs the generated parameter calculation information to acquire a parameter calculation result (step S7).

Then, the station installation support device 10 determines whether or not one or more parameter calculation results that match the parameter calculation condition exist (step S8). If the one or more parameter calculation results that match the parameter calculation condition exist (Yes in step S8), the station installation support device 10 compiles the parameter calculation results that match the parameter calculation condition, and generates and records a parameter pattern (step S9). If the station installation calculation results that match the parameter calculation condition do not exist in the determination in step S8 (No in step S8), the station installation support device 10 corrects the parameter calculation information (step S10), and the processing returns to step S7.

The parameter calculation condition includes information as an evaluation condition for the parameter calculation result. Examples of the parameter calculation condition include a value of a transmission output and a value of a bandwidth.

Examples of correction of the parameter calculation information include a change in the parameter calculation method, an increase in the number of available channels, and a change in the maximum bandwidth. If interference cannot be avoided because the number of available channels is small, for example, the number of available channels is increased so that the parameter calculation result that matches the parameter calculation condition is easily obtained.

Then, the station installation support device 10 generates wireless performance evaluation information based on the parameter pattern, the wireless performance evaluation condition, and the wireless signal evaluation result, and outputs the generated wireless performance evaluation information to the wireless performance evaluation unit 50 to acquire a wireless performance evaluation result (step S11).

Then, the station installation support device 10 determines whether or not one or more wireless performance evaluation results that match the wireless performance evaluation condition exist (step S12). If the one or more wireless performance evaluation results that match the wireless performance evaluation condition exist (Yes in step S12), the station installation support device 10 compiles the wireless performance evaluation results that match the wireless performance evaluation condition, and generates and records a wireless performance evaluation pattern (step S13). If the wireless performance evaluation results that match the wireless performance evaluation condition do not exist in the determination in step S12 (No in step S12), the station installation support device 10 corrects the station installation calculation information and the parameter calculation information (step S14), and the processing returns to step S3.

The wireless performance evaluation condition includes information as an evaluation condition for the wireless performance evaluation result. Examples of the wireless performance evaluation condition include an uplink throughput, a downlink throughput, an RTT, and an area cover result.

The respective corrections of the station installation calculation information and the parameter calculation information in step S14 are respectively similar to processes in steps S6 and S10.

If the wireless performance evaluation results do not match the wireless performance evaluation result in step S12 although a parameter is optimized to increase a wireless capacity in step S7, the possibility that there is a problem in the station installation in step S3 can be high. Therefore, in step S14, it is effective to correct the station installation calculation information, increase the wireless capacity in step S3, and perform the process in step S7 again rather than to correct the parameter calculation information and perform the process in step S7.

In steps S7 and S11, after the order of performing the wireless performance evaluation is determined based on the evaluation performance priority in the station installation pattern generated in step S5, determination is performed for the acquired parameter calculation result and wireless performance evaluation result. When a requirement is satisfied, subsequent performance of the wireless performance evaluation for the station installation pattern is terminated, that is, the wireless performance evaluation result matches the wireless performance evaluation condition early in step S12 so that a processing time period required for the wireless performance evaluation can be reduced.

As the requirement, one or a plurality of required values can be determined for items included in the wireless performance evaluation result and the station installation evaluation result. For example, an uplink throughput, a downlink throughput, an RTT, an area cover result, and the like can be each set as the requirement.

Then, the station installation support device 10 generates the station installation evaluation result based on the wireless performance evaluation pattern, the station installation evaluation condition, the wireless signal evaluation result, and the station installation pattern and records the station installation evaluation result, and outputs the station installation evaluation result to the user 2 (step S15).

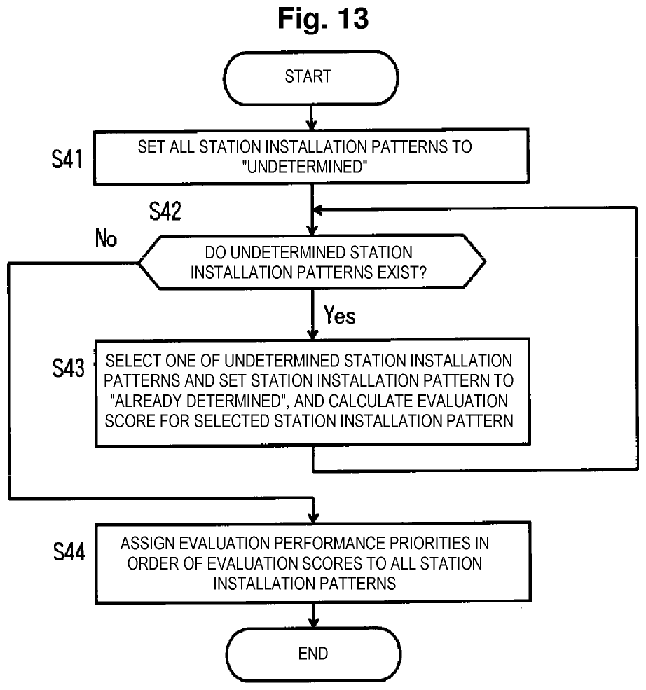

FIG. 13 illustrates an example of a setting processing procedure of an evaluation performance priority for a station installation pattern. A setting flow is detailed description of an evaluation performance priority setting in a station installation pattern in step S5 in a station installation processing flow illustrated in FIG. 12.

First, the station installation support device 10 sets all station installation patterns to “undetermined” (step S41).

Then, the station installation support device 10 determines whether or not the undetermined station installation patterns exist (step S42). If the undetermined station installation patterns exist (Yes in step S42), the station installation support device 10 selects one of the undetermined station installation patterns and sets the undetermined station installation pattern to “already determined”, and calculates an evaluation score for the selected station installation pattern (step S43). If the undetermined station installation pattern does not exist (No in step S42), the station installation support device 10 respectively assigns evaluation performance priorities to the station installation patterns in the order of evaluation scores respectively calculated for the station installation patterns (step S44), and the processing ends.

In a method of calculating an evaluation score, the evaluation score can be calculated using criteria such as the number of station installations being as small as possible, a total of RSSI values at a measurement point in an area (a sum in a true value) being high, and a sum of distances among wireless base stations being small and combining the criteria.

The station installation support system according to the present invention has been described above with reference to the drawings. In the conventional technique, pieces of software need to be used so that much time and effort and a large operation amount are required. On the other hand, the described station installation support device 10 includes interfaces respectively for a user and processing units and the user uses an enhanced station installation manager. Therefore, station installation operations such as a calculation of a plurality of station installation patterns based on an installation condition, a parameter optimization for each of the station installation patterns, and a throughput evaluation based on each parameter optimization result can be integrally performed, and a station installation satisfying a required performance can be performed with little time and effort. In the described station installation support device 10, when priorities are respectively assigned to station installation patterns, and calculation processing is finished if a result satisfying a requirement is obtained while respective processes of the station installation patterns are advanced in descending order of the priorities, an operation time period can be reduced.

The station installation support device 10 can operate in cooperation with not only processing units (pieces of software) so far listed but also other processing units (pieces of software) and an integrated software if each of the processing units corresponds to a user interface and a common interface for the processing units included in the station installation support device 10, and can flexibly perform a station installation.

### REFERENCE SIGNS LIST

10 Station installation support device
11 User interface unit
12 Information processing unit
13 Information storage unit
14 Common interface unit
20 Wireless signal evaluation unit
30 Station installation calculation unit
40 Parameter calculation unit
50 Wireless performance evaluation unit

1. A station installation support method for performing a station installation design of a wireless base station satisfying a required performance and a parameter design, the station installation support method comprising:
a step 1 of acquiring a station installation calculation condition required to calculate a station installation of the wireless base station, a parameter calculation condition required to calculate a parameter of the wireless base station, a wireless performance evaluation condition required to evaluate a wireless performance, and a station installation evaluation condition required to evaluate the station installation;
a step 2 of outputting wireless signal evaluation information required to measure a wireless environment to a wireless signal evaluation unit to acquire a wireless signal evaluation result;
a step 3 of outputting station installation calculation information generated based on the station installation calculation condition and the wireless signal evaluation result to a station installation calculation unit to acquire a station installation calculation result, compiling a station installation calculation result that matches the station installation evaluation condition to generate a station installation pattern, and correcting station installation calculation information when a station installation calculation result that matches the station installation evaluation condition is not obtained and repeating acquisition of a station installation calculation result;
a step 4 of outputting parameter calculation information generated based on the station installation pattern, the parameter calculation condition, and the wireless signal evaluation result to a parameter calculation unit to acquire a parameter calculation result, compiling a parameter calculation result that matches the parameter calculation condition to generate a parameter pattern, and correcting the parameter calculation information when a parameter calculation result that matches the parameter calculation condition is not obtained and repeating acquisition of a parameter calculation result;
a step 5 of outputting wireless performance evaluation information generated based on the parameter pattern, the wireless performance evaluation condition, and the wireless signal evaluation result to a wireless performance evaluation unit to acquire a wireless performance evaluation result, compiling a wireless performance evaluation result that matches the wireless performance evaluation condition to generate a wireless performance evaluation pattern, correcting the station installation calculation information and the parameter calculation information when a wireless performance evaluation result that matches the wireless performance evaluation condition is not obtained and returning to the step S3; and
a step 6 of generating a station installation evaluation result to be provided for a station installation design of the wireless base station and a parameter design based on the wireless performance evaluation pattern, the station installation evaluation condition, the wireless signal evaluation result, and the station installation pattern.

2. The station installation support method according to claim 1, wherein
in the step 4 and the step 5, the order of performing a parameter calculation and a wireless performance evaluation is determined based on an evaluation performance priority in the station installation pattern generated in the step 3, the acquired wireless performance evaluation result is determined, and subsequent performance of the parameter calculation and the wireless performance evaluation for the station installation pattern is terminated when a required condition is satisfied.

3. A station installation support system for performing a station installation design of a wireless base station satisfying a required performance and a parameter design, the station installation support system comprising:
a station installation support device that acquires a station installation calculation condition required to calculate a station installation of the wireless base station, a parameter calculation condition required to calculate a parameter of the wireless base station, a wireless performance evaluation condition required to evaluate a wireless performance, and a station installation evaluation condition required to evaluate the station installation and performs the station installation design and the parameter design;
a wireless signal evaluation unit that outputs a wireless signal evaluation result corresponding to wireless signal evaluation information;
a station installation calculation unit that outputs a station installation calculation result corresponding to station installation calculation information;
a parameter calculation unit that outputs a parameter calculation result corresponding to parameter calculation information; and
a wireless performance evaluation unit that outputs a wireless performance evaluation result corresponding to wireless performance evaluation information,
wherein the station installation support device generates wireless signal evaluation information and outputs the wireless signal evaluation information to the wireless signal evaluation unit, generates the station installation calculation information based on the station installation calculation condition and the wireless signal evaluation result, generates a station installation pattern based on the station installation calculation result outputted by the station installation calculation unit, which matches the station installation evaluation condition, generates the parameter calculation information based on the station installation pattern, the parameter calculation condition, and the wireless signal evaluation result, generates a parameter pattern based on the parameter calculation result outputted by the parameter calculation unit, which matches the parameter calculation condition, generates the wireless performance evaluation information based on the parameter pattern, the wireless performance evaluation condition, and the wireless signal evaluation result, generates a wireless performance evaluation pattern based on the wireless performance evaluation result outputted by the wireless performance evaluation unit, which matches the wireless performance evaluation condition, and generates a station installation evaluation result of the wireless based station based on the wireless performance evaluation pattern, the station installation evaluation condition, the wireless signal evaluation result, and the station installation pattern.

4. The station installation support system according to claim 3, wherein
the station installation support device is configured to determine the order of performing a parameter calculation and a wireless performance evaluation based on an evaluation performance priority in the station installation pattern, determines the acquired wireless performance evaluation result, and terminates subsequent performance of the parameter calculation and the wireless performance evaluation for the station installation pattern when a required condition is satisfied.
